(19) United States
(12) Patent Application Publication
(10) Pub. No.: US 2025/0128392 A1
(43) Pub. Date: Apr. 24, 2025

(54) Work apparatus for use in the plumbing industry, in particular a pressing tool for pipes and the like, and method for operating the work apparatus

(71) Applicant: REMS GmbH & Co KG, Waiblingen (DE)

(72) Inventors: Christoph Föll-Laubengeiger, Stuttgart (DE); Rudolf Wagner, Stuttgart (DE)

(73) Assignee: REMS GmbH & Co KG, Waiblingen (DE)

(21) Appl. No.: 18/918,578

(22) Filed: Oct. 17, 2024

(30) Foreign Application Priority Data
Oct. 19, 2023 (DE) 10 2023 004 230.7
Oct. 13, 2024 (DE) 102024003360.2

(51) Int. Cl. B25F 1/00; B25F 5/00

(52) U.S. Cl. CPC B25F 1/006; B25F 5/00

(57) ABSTRACT

A work apparatus is in particular a press tool for pipes and the like and has a drive unit which is provided for a tool of the work apparatus and to which an electronic tool controller is assigned. In order to enable optimal operation with this work apparatus, the tool controller has at least one microcontroller, which is provided with at least one communication module, which can be preconfigured so that the microcontroller independently establishes a network connection via the communication module and connects to a cloud or a server/data storage and exchanges data. The work apparatus establishes a network connection after being powered on and/or at time intervals/times and/or after certain operating states, connects to a cloud or a server/data storage and exchanges data.

### CROSS-REFERENCE TO RELATED APPLICATION

This application claims the benefit of German Patent Applications DE 10 2023 004 230.7, filed on Oct. 19, 2023, and DE TBD filed on Oct. 13, 2024, the contents of which is incorporated by reference in their entireties.

### TECHNICAL FIELD

The disclosure relates to a work apparatus, in particular a press tool for pipes and fittings, and to a method for operating such a work apparatus.

### BACKGROUND

Work apparatuses in the form of press tools with which press fittings for pipe systems are pressed are generally known. A drive unit drives pressing tongs such that the press fitting is pressed radially around its circumference by the pressing tongs. The drive unit is designed in such a way that the pressing tongs are opened after the pressing process has been completed so that the press tool can be removed from the pipe system/the press fitting.

### SUMMARY

The present application presents a work apparatus and a method for operating the work apparatus that enable an optimal mode of operation. This is achieved by the work apparatus and the method as disclosed herein.

The work apparatus has a tool controller with at least one microcontroller. The microcontroller is provided with at least one communication module. The at least one communication module can be preconfigured so that the microcontroller independently establishes a network connection via the communication module and connects to a cloud or a server/data storage. Data can be exchanged with the cloud or the server/data storage.

The term “independent” means that, on the one hand, the network connection is established without user intervention or, on the other hand, that the user must give an activation signal in order for the network connection to be established.

In some configurations, the microcontroller establishes a network connection via the communication module without user input. In other configurations, the microcontroller establishes a network connection via the communication module based on a user input.

In an advantageous embodiment, the microcontroller establishes a network connection via the communication module at regular or irregular time intervals or times.

In another advantageous embodiment, the microcontroller establishes the network connection via the communication module during or after certain operating states.

The communication module is advantageously a Wi-Fi module. It can be used to send or retrieve operating and/or setting data from the work apparatus to the cloud or to the server/data storage.

The Wi-Fi module is advantageously encapsulated within the first microcontroller. This ensures a high transmission quality through the Wi-Fi module.

A GSM module can also be used as the communication module, with which data can also be exchanged in a simple manner.

Other possible communication modules include CSD (Circuit Switched Data), HSCSD (High Speed Circuit Switched Data), GPRS (General Packet Radio Service), EDGE (Enhanced Data Rates for GSM), and the like.

It is particularly advantageous if the work apparatus is designed in such a way that firmware updating of the microcontroller is possible via at least one wireless interface. Examples of wireless interfaces that can be considered are WLAN, a cellular network, Bluetooth, WiMAX, IrDA, Low Power Wide Area Network (LPWAN) and other well-known wireless interfaces.

In an advantageous embodiment, the microcontroller can be divided into a first microcontroller and at least one further microcontroller. In this case, the microcontrollers are advantageously connected to one another bidirectionally, so that data/signal transmission in both directions is possible.

The first microcontroller is advantageously arranged on a circuit board which is accommodated in a housing of the work apparatus or of a battery pack.

In a preferred embodiment, the microcontroller is provided with interfaces. They are advantageously provided at least for at least one internal or external memory, for at least one RTC, for at least one camera, for at least one light source, for at least one microphone, for at least one signal generator, for at least one sensor, for at least one actuator, for at least one switch, for at least one interface module of a rechargeable battery. A wide variety of components of the work apparatus can be connected via these interfaces. Depending on the equipment of the work apparatus, all or only some of the interfaces of the microcontroller may be populated.

Advantageously, a human-machine-interface (HMI) controller can be connected to one of the interfaces of the first microcontroller, with which HMI controller operating and/or setting data of the work apparatus can be set.

It is advantageous if the transmission of data from the memory module to a cloud storage takes place asynchronously of processing by the work apparatus. The data transmission is thus independent of the respective work process that is currently being carried out with the work apparatus and regardless of whether there is a connection to the cloud.

The work apparatus is advantageously provided with at least one display for operating and/or setting data, so that necessary settings can be made directly on the work apparatus. An additional display device, such as a mobile phone or a computer, is therefore not required. This is particularly advantageous if a mobile phone or a computer is not available at the workplace or if data transmission via WLAN or Bluetooth or GSM module is not possible. The necessary settings can then be made directly on the work apparatus.

The setting of the operating and/or setting data is possible in a simple manner if the work apparatus is provided with control elements, for example with buttons, with which the operating and/or setting data can be set.

In an advantageous embodiment, the circuit board is designed in two parts. The two circuit board parts are located in different housing areas of the work apparatus. However, the circuit board can also be designed in one piece.

An advantageous embodiment results when one circuit board part is accommodated in a housing area forming a handle and the other circuit board part is accommodated in a housing area accommodating the power supply. The two-part design of the circuit board makes it possible to accommodate the tool controller even in compact devices.

Advantageously, sensors and actuators are connected to the second microcontroller.

The sensors detect operating conditions such as pressure, temperature, etc. The corresponding signals are fed to the second microcontroller, which processes these signals and/or feeds them to the first microcontroller.

The second microcontroller controls the actuators, such as the drive unit, which is advantageously an electric motor.

The use of the two microcontrollers makes it possible to divide the functions and working methods of the work apparatus. In particular, the second microcontroller controls the workflow of the work apparatus, while the first microcontroller is mainly used for machine settings and for data transmission to the Internet.

An energy supply is advantageously connected to the second microcontroller. With the help of the second microcontroller, it is possible, for example, to monitor whether sufficient voltage is present before the start of a work process in order to carry out the planned workflow completely and safely. If this is not possible, a corresponding warning signal is generated and/or the drive unit of the work apparatus is not even started, or it is stopped.

In an embodiment of the work apparatus as a press tool for pipes and the like, the tool controller is provided with at least one microcontroller and at least one microphone and/or at least one camera. Using the microphone and/or camera, a voice recording and/or an image/video recording can be made. For example, for each pressing process, the user of the press tool can make a recording of the pressing area and/or a voice recording before and/or after the pressing.

In a further advantageous embodiment, the microcontroller has at least one communication module, which connects the press tool to a cloud, a server/data storage or a terminal and transmits the voice recording and/or the image/video recording.

In a method for operating the work apparatus, the work apparatus establishes a network connection after switching on and/or at time intervals/times and/or after certain operating states. The work apparatus connects to a cloud or a server/data storage. Data is exchanged between the work apparatus and the cloud or the server/data storage.

The network connection is advantageously established at regular time intervals or at regular times.

A particularly advantageous procedure results when an access point of the work apparatus is activated. The data of the network to be used is transmitted to the work apparatus via this access point. In this case, the work apparatus can advantageously store the connection, so that the work apparatus can establish the connection independently in the future.

It is advantageous if work data, such as date, time, number of work performed, position determination of the work apparatus, and the like, are transmitted to the work apparatus via the wireless connection. For example, the date and time can be recorded for each work process. For example, the number of work processes carried out can also be stored so that, for example, a signal can be generated when a certain number of work processes are reached in order to check the operating state of the work apparatus. If, for example, data relating to the position determination of the work apparatus is transmitted, the location at which the work apparatus was used can be visualized on a map.

It is advantageous if data recorded in the work apparatus during the work process are fed to the external storage or the cloud during/or after the work process. As a result, this data is always available and can be transmitted back to the work apparatus from external storage or the cloud as required or, for example, to a computer, a mobile phone or the like.

The invention is explained in more detail below with reference to embodiments illustrated in the drawings.

### BRIEF DESCRIPTION OF THE DRAWINGS

FIG. 1 shows a side view of a work apparatus in the form of a press tool,

FIG. 2 shows a view in the direction of arrow II in FIG. 1,

FIG. 3 shows the interaction of the work apparatus with a battery pack as a power supply, a cloud, and with applications,

FIG. 4 shows a block diagram of a tool controller of the work apparatus, and

FIG. 5 shows a block diagram of a tool controller of a further embodiment of a work apparatus.

### DETAILED DESCRIPTION

In the following, a press tool is described as an example of a work apparatus for plumbing applications. Cleaning and flushing devices for pipeline systems are further examples of plumbing tools. Therefore, when reference is made to a press tool below, this explains the invention with regard to one particular species of plumbing tools. However, the invention can be applied to the broader genus of plumbing tools, and even more broadly to a wide range of work apparatuses beyond plumbing applications.

Press tools are used in particular in the plumbing industry and are used, for example, to press pressing sleeves of a press fitting onto a pipe and thus to produce a pipe connection.

The press tool PW as a work apparatus has pressing tongs 1. The pressing tongs 1 have two pressing jaws 2, 3. The pressing jaws 2, 3 can be pivoted against each other. Each of the pressing jaws 2, 3 can be pivoted about an axis 4, 5. The two pressing jaws 2, 3 are designed as two-armed levers.

The tongs design is not limited to two pressing jaws but includes a plurality of pressing jaws forming a pressing ring. It consists, for example, of three pressing jaws which are connected to one another in an articulated manner, and which surround the workpiece to be pressed and plastically deform the workpiece over its circumference during the pressing process.

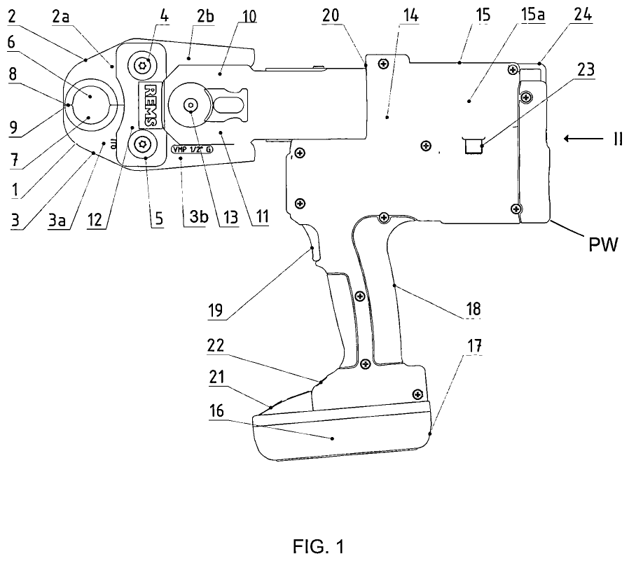

Each pressing jaw 2, 3 is provided with a recess 6, 7 at one end. FIG. 1 shows the two pressing jaws 2, 3 resting against each other with their ends 8, 9. The ends 8, 9 outwardly delimit the recesses 6, 7. The recesses 6, 7 form a receptacle for the pressed pressing sleeve (not shown) or the pressed tube.

The recesses 6, 7 (pressing contour) are each provided on the one lever arm 2a, 3a of the pressing jaws 2, 3. The other lever arms 2b, 3b of the pressing jaws 2, 3 are provided on their mutually facing inner sides with guide surfaces 10, 11 for pressing rollers (not shown), which are provided on an axially displaceable feed piston.

In the starting position, this feed piston with the pressing rollers has been retracted to such an extent that the pressing tongs 1 can be opened to insert the object to be pressed into the recesses 6, 7. The arms 2b, 3b of the pressing jaws 2, 3 are spring-loaded in such a way that they rest against the inserted object. When the feed piston is extended, the pressing rollers come into contact with the guide surfaces 10, 11, as a result of which the pressing jaws 2, 3 are pivoted about the pivot axes 4, 5 in such a way that the lever arms 2a, 3a pivot towards each other until, at the end of the pressing process, they assume the position shown in FIG. 1, in which the pressing jaws 2, 3 lie against each other with their end faces.

The feed piston can be moved mechanically, but also electrically, hydraulically or pneumatically to carry out the pressing process.

The pivot axes 4, 5 are located in connecting plates 12, which are provided on opposite sides of the pressing tongs 1. In FIG. 1, only one connecting plate 12 is visible. The other connecting plate is located on the back of the pressing tongs 1, which is not visible.

The pressing tongs 1 are detachably attached to a drive unit 14 of the press tool PW by a retaining bolt 13.

The drive unit 14 has a housing 15, in which drive means for the feed piston are accommodated, with which the pressing rollers are actuated to close the pressing tongs 1. The drive unit 14 may, for example, be an electric motor, a hydraulic drive including a hydraulic cylinder, or a pneumatic drive including a pneumatic cylinder.

In the exemplary embodiment, the press tool is a portable power tool that is operated using a battery pack 16 as a power supply. The battery pack 16 has a housing 17. The housing 17 is arranged at the free end of a transversely projecting handle 18. The handle 18 is part of the housing 15. Components of the drive unit 14 can be accommodated in the handle 18. The housing 17 is detachably attached to the free end of the handle 18, so that the battery pack 16 can easily be removed for charging and replaced by a charged battery pack. A switch 19 is located on the handle 18, with which the press tool 1 can be switched on.

The handle 18 connects the battery pack 16 to a housing part 15a, in which the drive for the feed piston is accommodated.

If required, the work area of the press tool can be illuminated with at least one work light 20. The work light 20 is advantageously an LED light and is advantageously arranged on the top side of the housing 15.

A charge level indicator 21 is provided on the housing 17 of the battery pack 16. The charge level indicator 21 provides the user of the press tool with information about the charge level of the battery pack 16. A further display 22, which is advantageously provided in the region of the battery pack 16 on the handle 18, can be a further workplace lighting and/or can provide information about the quality of the pressing process or other information.

A reset button 23 is preferably arranged on one side of the housing 15, by which the pressure in the hydraulic system of the press tool PW can be reduced (in error situations). A carrying eye 24, in which a carrying strap can be suspended, is advantageously provided on the rear side of the housing 15 facing away from the pressing tongs 1.

At least one input element 26, 27, with which settings of the press tool PW can be adjusted, is located on the rear side of the housing 15. Possible input elements include buttons, touch screens, gesture control, voice control, HID (Human Interface Device) and the like.

Furthermore, a display 28 is advantageously provided on the rear side, on which the product can be configured and/or errors, notes, statistics, evaluations and the like can be displayed. The display 28 is advantageously equipped with an OLED screen, providing excellent image quality.

Finally, a machine state control 29 is provided on the rear side of the housing 15, with which, for example, the battery state or an error can be displayed. Further, an on/off button 30 is provided on the rear side of the housing 15, with which the press tool PW can be switched on and off.

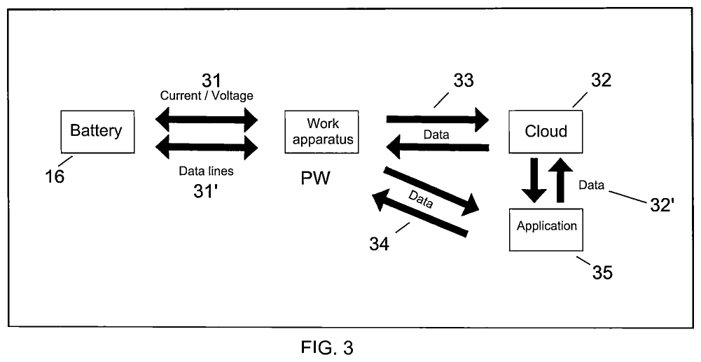

The press tool PW is multifunctional and provides the user a wide variety of settings, monitoring capability, and bidirectional data transmission. As shown in FIG. 3, the battery pack 16 is connected to the press tool PW via a current/voltage connection 31, so that current/voltage can be transported in both directions. In addition, the condition of the battery pack 16, e.g. its charge level, its temperature, or its SOH (state of health) is monitored. For this purpose, an exchange of data 31′ between the press tool PW and the battery pack 16 is provided in both directions. For example, the start of the respective pressing process can be monitored and controlled as a function of the condition of the battery pack 16 or the battery pack 16 can be recharged by recuperation.

The press tool PW can be connected to a cloud system 32, allowing two-way transfer and storage of data 34.

In addition, the press tool PW can be connected to an application 35 in such a way that data 33 can be transmitted and stored in both directions.

The cloud 32 can be connected to an application 35 in such a way that data 32′ can be transmitted and stored in both directions. Further processing, e.g. evaluation, enrichment, or presentation of the data can take place in the cloud 32 and/or in the application 35.

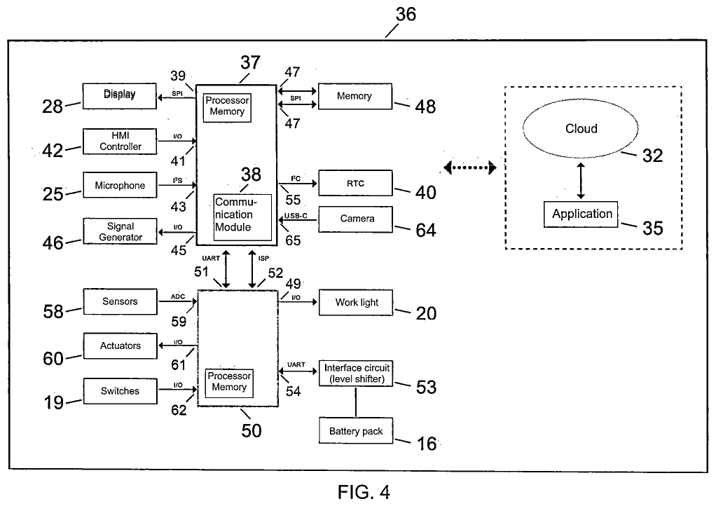

The electronic tool controller provided for the multifunctionality of the press tool PW is explained in more detail with reference to FIG. 4.

The tool controller has a main circuit board 36, which is advantageously accommodated in the housing 15 of the press tool. It is also possible to design the main circuit board 36 in several parts, whereby, for example, one main circuit board part can be accommodated in the housing part 15a, 18 and another main circuit board part can be accommodated in the housing 17 of the battery pack 16. The main circuit board parts can be arranged at an angle to each other, for example of about 80°, and/or be firmly connected to each other.

The control includes a microcontroller 37 or a network of microcontrollers. For example, the microcontroller 37 is located on the main circuit board 36. The microcontroller 37 has various interfaces, which will be explained below.

A communication module 38, which can establish a connection to the Internet, is located on the microcontroller 37. The communication module 38 is, for example, a Wi-Fi module. The communication module 38 can also be used to connect to the cloud 32, which is, for example, a Microsoft Azure cloud that has a collection of servers and network components on which a complex set of distributed applications can be run.

The communication module 38 allows independent or controlled updating of the firmware (OTA) of the microcontrollers 37 and 50 by prior download of updated firmware, for example from the cloud 32.

Different components are connected to the microcontroller 37 via corresponding interfaces. For example, a display board 28 arranged on the main circuit board 36 is connected via an interface 39, which is an SPI interface.

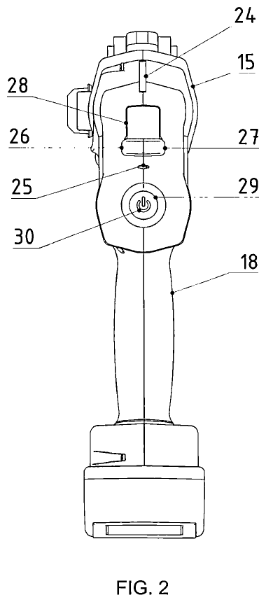

Via an interface 41, which is, for example, an I/O interface, the microcontroller 37 receives signals from an HMI controller 42, via which settings of the press tool PW can be adjusted, for example. The input element 26, 27 (FIG. 2) is provided for operating the HMI control 42.

The microcontroller 37 receives signals from the microphone 25 via a further interface 43, preferably an I²S interface. Via the interface 43, the microcontroller 37 receives the digital audio data from the microphone 25, which, like the HMI control 42, can be located on the main circuit board 36.

In principle, it is also possible to control the press tool PW by a mobile device, e.g. a smartphone or iPad, which can also be designed as a device that can be placed on the press tool PW.

Via an interface 45, preferably an I/O interface, the microcontroller 37 sends, for example, signals, melodies, or audio recordings to a signal generator 46 (for example a buzzer or loudspeaker), for example as confirmation during setting operations on the press tool PW.

A memory 48 is connected to the microcontroller 37 via interfaces 47, preferably an SPI interface, in which data of the press tool, such as pressing time, pressing numbers, pressing pressures, audio recordings, image/video recordings, state of charge of the battery pack 16 and the like, can be stored or data can be retrieved from the microcontroller 37.

An RTC (real time clock) 40 is connected to the microcontroller 37 via an interface 55, preferably an I²C interface, which provides the date and time for further use.

A camera 64 is connected to the microcontroller 37 via an interface 65, preferably a USB-C interface, which transmits image/video recordings to the memory 48 via the interface 47 and the microcontroller 37.

The microcontroller 37 is therefore used for the following functionalities: Control of the display 28, the HMI control 42, the microphone 25, the signal generator 46, the memory 48, the RTC 40, and the camera 64.

A further microcontroller 50 is provided for motor control. The further microcontroller 50 is located, for example, on the main circuit board 36 and is connected to the microcontroller 37 via two interfaces 51, 52. The interface 51 is advantageously a UART interface (for data exchange) and the interface 52 is advantageously an ISP interface (for programming).

The battery pack 16 is connected to the microcontroller 50 via an interface component 53. The interface component 53 is used to carry out required level shifting between the battery pack 16 and the microcontroller 50. A bidirectional data/signal exchange with the interface component 53 is possible via an interface 54, preferably a UART interface.

The work light 20 is connected to the microcontroller 50 via an interface 49, preferably an I/O interface.

As can be seen from FIG. 4, all essential components of the control system are housed on the main circuit board 36, which has relatively small dimensions so that it can also be accommodated in small devices, such as the press tool PW.

The microcontroller 37 enables communication with the cloud 32 via the communication module 38. The WLAN range in the open field is sufficiently large so that the press tool PW can be used without having to worry about the connection to the cloud 32 being interrupted. If the connection to the cloud 32 is nevertheless interrupted, all resulting data are buffered in the memory 48 of the press tool PW and transmitted to the cloud 32 during a later connection.

Settings of the press tool PW can be adjusted with the input elements 26, 27 (FIG. 2). The respective values are displayed in the display 28. Via the HMI control 42, the corresponding data is transferred via the interface 41 to the microcontroller 37, which stores them in the memory 48. The HMI control 42 can be used to easily set the mode of operation of the press tool PW, the intensity of the lighting of the work light 20, the duration of the lighting, the standby time, warning tones, the time and date as well as the date and time format, and to switch the signal generator 46 on or off. It is also advantageously possible to set the time zone in which the press tool PW is used. Furthermore, the units of measurement and the HMI language can also be set using the HMI control 42.

Audio messages can be recorded with the microphone 25 and fed via the interface 43 to the microcontroller 37. The microcontroller 37 can store the audio messages in the memory 48. Advantageously, the audio message can be converted into a text message via the cloud 32 and, if necessary, stored again in the memory 48 of the press tool PW.

Signals from sensors 58 are fed to the microcontroller 50 via an interface 59, which is advantageously an ADC interface. Sensors that can be used include, for example, pressure sensors, temperature sensors or safety sensors that detect the pressing pressure, the temperature of the press tool PW or the complete closing of the pressing tongs retaining bolt 13 or the pressing tongs used (contour, size, serial number of the pressing tongs, number of pressings carried out). If critical values are exceeded, corresponding warnings can be issued by the microcontroller 37 via the signal generator 46.

The microcontroller 50 further serves to operate actuators 60 that are connected to an interface 61, preferably an I/O interface. An example of such an actuator 60 is the drive unit 14.

Finally, a switch 19 is connected to an interface 62, preferably an I/O interface, of the microcontroller 50.

If the press tool PW is switched on with the switch 30 (FIG. 2) and the pressing process is started with the switch 19, the controller starts the drive unit 14 when the rechargeable battery of the battery pack 16 is sufficiently charged and the pressing tongs retaining bolt 13 is completely closed.

Various operating modes can be set via the HMI control 42, for example as follows:
Operating mode 1: The switch 19 must be permanently pressed during the pressing process. The press tool PW starts the pressing process and ends it automatically by emitting an acoustic signal (click) and automatically runs back (forced sequence). The switch 19 must be released at the end of the pressing process.
Operating mode 2: The switch 19 must be permanently pressed during the pressing process. The press tool PW stops shortly before the required pressing pressure is reached. The complete closing of the pressing tongs, the pressing ring, and the pressing segments at the end of the pressing process can thus be better observed. The pressing process must be continued by pressing the switch 19 again. When switch 19 is pressed, the press tool PW automatically terminates the pressing process by emitting an acoustic signal (click) and automatically runs back (forced sequence). The switch 19 must be released at the end of the pressing process.
Operating mode 3: The press tool PW starts the pressing process when the switch 19 is pressed and automatically continues to run from the beginning of the pressure build-up even after the switch 19 has been released and ends the pressing process by emitting an acoustic signal (click) and automatically runs back (forced sequence).

Depending on the design of the press tool PW, more or fewer operating modes can be provided.

Via the microprocessor 50 and the interface component 53, the controller knows whether the voltage of the battery pack 16 is sufficient for a desired pressing process. If the battery voltage falls below a specified lower limit, further pressing is no longer possible.

The sensor signals are transmitted to the microprocessor 50. The microprocessor 50 monitors, for example, whether the pressing pressure is within a predetermined pressing pressure range or whether the pressing tongs retaining bolt 13 is completely closed. If this is the case, the microprocessor 50 sends a corresponding signal via the interface 51 to the microprocessor 37. The microprocessor 37 sends a corresponding signal via the interface 39 to the display 28. The display 28 lights up accordingly and/or a message is displayed. Different light colors of the work light and/or other lights can be used to indicate correct pressing pressure and incorrect pressing pressure, so that the user can immediately see whether the pressing pressure was sufficient or within predetermined limit values. The same applies, for example, to a pressing tongs retaining bolt 13 that is not completely closed or other conditions.

With the tool controller it is also advantageously possible, for example, to record the pressing pressure curve and the maximum pressing pressure via the sensors 58 and to store the sensor data. The tool controller monitors whether the pressing force required during pressing has been achieved, which can be determined by monitoring the pressing pressure.

With the help of the tool controller, the press tool PW can be connected to the cloud 32. This connection is made via the communication module 38, for example via a Wi-Fi module. For this purpose, the ACCESS-point can be activated in the press tool PW in order to transmit the Wi-Fi network to be used to the press tool via a configuration page that is displayed, for example, on a mobile terminal. Thereafter, the press tool PW connects independently to the cloud 32. The press tool PW advantageously stores the connection, so that the press tool can establish the connection independently in the future.

Via the WLAN connection of the press tool, it is easily possible to receive the date and time and to transfer them to the RTC 40 (real time clock), for example, so that with each pressing, the data can be stored in the memory 48 with a correct time stamp and displayed on the display 28.

Furthermore, it is possible, for example, to use the tool controller to store the operating times of the press tool PW and the number of pressings carried out in the memory 48. The total operating time of the tool and the total number of pressings carried out, as well as the individual operating time and the individual number of pressings carried out can be saved.

The battery voltage can also be stored in the cloud 32, as can, for example, the current/voltage profile, the remaining capacity of the rechargeable battery, the serial number of the rechargeable battery used, the internal temperature of the drive machine, the pressing time, the hardware status, and the firmware version.

When the Wi-Fi module 38 is switched on, the press tool PW scans the available Wi-Fi networks before each pressing and saves this information together with the pressing data.

After the data of a pressing has been transferred to the cloud 32, an asynchronous cloud function attempts to approximately determine the position of the pressing location by using a geolocation API. If the determination is successful, the determined geocoordinates (pressing location) are stored in the cloud 32 and can be visualized in an application 35 on a map, for example. Since all data of the drive machine is available in the cloud 32, all pressings carried out at a pressing location can also be displayed and called up in the map view.

The data and, if available, also an audio/image/video recording, are stored on the memory 48 located on the main circuit board 36 immediately after the pressing process. If there is an existing connection to the cloud 32, these stored data and, if applicable, recordings will be transferred to the cloud 32. If there is no existing connection, all stored data and recordings, if any, will be transferred as soon as a connection to the cloud 32 is re-established.

In order to keep the storage capacity of the memory 48 as small as possible, it is advantageous if the data in the memory 48 is automatically deleted after the data has been successfully transferred to the cloud 32.

If a mobile terminal is available at the pressing location of the press tool PW, a recording (photo, video, audio) can be made with it in order to record, for example, damage at the processing location, the installation location itself, and the like. The recordings can then be uploaded from the mobile terminal via the application 35, assigned to a pressing, and stored in the cloud 32.

Data stored in the cloud 32, e.g., settings of the press tool PW, are retrieved by the press tool PW and applied. For example, it is also possible to use the cloud 32 to set various usage locks when using the press tool PW and to transfer them to the press tool PW, such as an immediate lock to shut down the press tool PW or setting feedback intervals in the cloud as theft protection, setting time and date ranges as blocking times, setting to limit the number of pressings that can be carried out. The application 35 also provides the option of accessing all data using an authorization concept.

For security reasons, data transmission is ideally encrypted.

The tool controller is also advantageously designed in such a way that the data is not lost if a data transmission to the cloud 32 is interrupted. If transmission errors occur or the transmission of the data is interrupted, the data transmission is restarted as soon as there is a connection to the cloud 32. In this case, it is advantageous if the data is first always stored in the memory 48, from which the data is then transmitted to the cloud 32 as soon as the connection to the cloud 32 exists again.

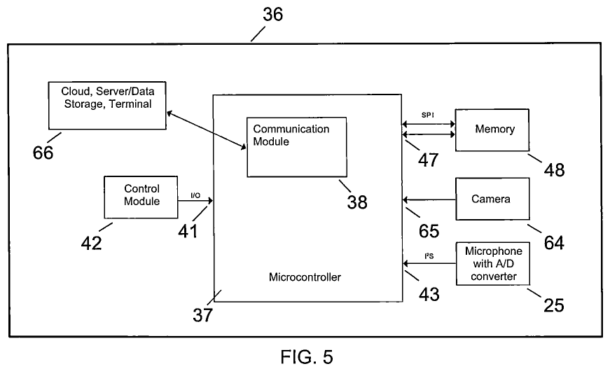

FIG. 5 shows the block diagram of a very simple embodiment of the work apparatus, in particular of the press tool PW. The microcontroller 37, which is provided with the at least one communication module 38, is located on the main circuit board 36. The at least one communication module 38 enables a connection to the environment 66. The environment 66 may be formed by the cloud 32, a server/data storage, or a terminal. This connection between the communication module 38 and the environment 66 is bidirectional.

The HMI control 42 is connected to the microcontroller 37 via the interface 41. The HMI control 42 in this case is formed by a control unit with which inputs can be made.

Incidentally, the microphone 25 is connected to the microcontroller 37 in the described manner via the interface 43, the memory 48 is connected via the interface 47, and the camera 64 is connected via the interface 65.

The microphone 25 is advantageously provided with an A/D converter in accordance with the previous exemplary embodiment.

The camera 64 and the microphone 25 can be used to capture image/video and voice recordings. Via the communication module 38, the signals of the voice recording and/or the image/video recording can be transmitted to the environment 66, which can be formed by the cloud 32, by a server/data storage or by a terminal device.

Even with this simple embodiment, voice and/or image/video recordings can be made. They may be stored in the cloud 32, for example. These data are transmitted in the manner described with reference to the previous exemplary embodiment.

What is claimed is:

1. A work apparatus, comprising:
a tool (1);
a drive unit (14) for driving the tool (1); and
an electronic tool controller operatively connected to the drive unit, the electronic tool controller including
a microcontroller (37, 50) with a communication module (38),
wherein the communication module (38) is configured to independently establish a network connection between the microcontroller (37, 50) and a cloud (32) or a server/data storage via the communication module (38) and to exchange data.

2. The work apparatus according to claim 1,
wherein the microcontroller (37, 50) establishes the network connection via the communication module (38) at regular or irregular time intervals or times.

3. The work apparatus according to claim 1,
wherein the microcontroller (37, 50) establishes the network connection via the communication module (38) during or after certain operating states.

4. The work apparatus according to claim 1,
wherein the communication module (38) is a Wi-Fi module.

5. The work apparatus according to claim 1,
wherein the communication module (38) is a GSM module.

6. The work apparatus according to claim 1,
wherein the microcontroller (37, 50) comprises
a first microcontroller (37), and
a further microcontroller (50).

7. The work apparatus according to claim 6,
wherein the first microcontroller (37) and the further microcontroller (50) are bidirectionally connected to one another.

8. The work apparatus according to claim 6,
wherein the first microcontroller (37) is located on a circuit board (36) which is accommodated in a housing (15, 17, 18) of the work apparatus or of a battery pack (16).

9. The work apparatus according to claim 1,
wherein the microcontroller (37, 50) includes interfaces (39, 41, 43, 45, 47, 55, 65, 49, 54, 59, 61, 62) for interfacing with one or more of
an internal or external memory (48),
a RTC (40),
a camera (64),
a light source (20),
a microphone (25),
a signal generator (46),
a sensor (58),
an actuator (60),
a switch (19), or
an interface component (53) of a rechargeable battery pack (16).

10. The work apparatus according to claim 6,
wherein an HMI control (42) is connected to an interface (41) of the first microcontroller (37).

11. The work apparatus according to claim 1,
wherein the microcontroller (37, 50) is operatively connected to a memory (48), and
wherein a transmission of data from the memory (48) to the cloud (32) takes place asynchronously of processing by the work apparatus.

12. The work apparatus according to claim 1,
wherein the work apparatus has a display (22, 28) for operating data and/or setting data.

13. The work apparatus according to claim 1,
wherein the work apparatus is provided with control elements (26, 27) with which operating data and/or control data of the work apparatus can be set.

14. The work apparatus according to claim 1,
wherein the electronic tool controller includes a main circuit board (36), and
wherein the main circuit board (36) consists of two circuit board parts which are accommodated in different regions of a work apparatus housing (15, 18) or a battery pack housing (17).

15. The work apparatus according to claim 14,
wherein one of the two circuit board parts is accommodated in handle portion of the work apparatus housing (18) and another of the two circuit board parts is accommodated in the battery pack housing (17).

16. The work apparatus according to claim 1,
wherein the microcontroller (37, 50) includes a first microcontroller (37) and a second microcontroller (50), and
wherein sensors (58) and actuators (60) are connected to the second microcontroller (50).

17. The work apparatus according to claim 16,
wherein a power supply (16, 53) is connected to the second microcontroller (50).

18. The work apparatus according to claim 1,
wherein the electronic tool controller has a microphone (25) and/or a camera (64) and
wherein the electronic tool controller is configured for recording voice and/or image/video.

19. The work apparatus according to claim 18,
wherein the microcontroller (37) is configured to transmit a voice recording and/or an image/video recording to the cloud (32) or the server/data storage.

20. A method, comprising:
providing a work apparatus for pipes and fittings, including a tool (1),
a drive unit (14) for driving the tool (1),
an electronic tool controller operatively connected to the drive unit, the electronic tool controller including
a microcontroller (37, 50) with a communication module (38);
independently establishing a wireless network connection between the microcontroller (37, 50) and a cloud (32) or a server/data storage via the communication module (38); and
exchanging data between the microcontroller (37, 50) and the cloud (32) or the server/data storage after the work apparatus is powered on and/or at time intervals/times and/or after certain operating states.

21. The method according to claim 20,
wherein the wireless network connection is established at regular time intervals or at regular times.

22. The method according to claim 20, further comprising
activating an access point of the work apparatus and transmitting a wireless network to be used to the work apparatus, whereby the work apparatus can independently connect to the wireless network during further use.

23. The method according to claim 20, further comprising
transmitting work data including one or more of a date, a time, a number of work performed, and a position determination of the work apparatus to the work apparatus via the wireless network connection.

24. The method according to claim 20, further comprising
feeding data recorded in the work apparatus during a work process to the cloud (32) or the server/data storage during and/or after the work process.

25. The method according to claim 20, further comprising
updating a firmware of the microcontroller (37, 50) via the wireless network connection.
